(19) United States
(12) Patent Application Publication
(10) Pub. No.: US 2026/0111064 A1
(43) Pub. Date: Apr. 23, 2026

(54) MULTI-NODE SERVER, METHOD AND APPARATUS APPLIED TO MULTI-NODE SERVER, AND MEDIUM

(71) Applicant: SUZHOU METABRAIN INTELLIGENT TECHNOLOGY CO., LTD., Suzhou, Jiangsu (CN)

(72) Inventor: Lirong LU, Suzhou, Jiangsu (CN)

(21) Appl. No.: 19/168,640

(22) PCT Filed: May 30, 2024
(86) PCT No.: PCT/CN2024/096485

§ 371 Date: Sep. 24, 2025

(30) Foreign Application Priority Data
Jan. 30, 2024 (CN) 202410129788.X

(51) Int. Cl. G06F 1/26; G06F 13/362

(52) U.S. Cl. CPC G06F 1/266; G06F 13/362

(57) ABSTRACT

A multi-node server, a method and an apparatus applied to the multi-node server, and a medium are provided by the present application, The multi-node server includes a master node, a slave node, a power-on synchronization apparatus, and at least one shared card shared between the master node and the slave node; the target shared card is connected to the master node and the slave node, and the master node and the slave node are configured to supply power to the target shared card. The power-on synchronization apparatus includes an isolation module, a master node signal interconnection module, and a slave node signal interconnection module. The master node signal interconnection module is connected to the master node. The slave node signal interconnection module is connected to the slave node.

### CROSS-REFERENCE TO RELATED APPLICATION

This application claims the priority of the Chinese Patent application filed on Jan. 30, 2024 before the China National Intellectual Property Administration with the application number of 202410129788.X, and the title of “MULTI-NODE SERVER, METHOD AND APPARATUS APPLIED TO MULTI-NODE SERVER, AND MEDIUM”, which is incorporated herein in its entirety by reference.

### FIELD

The present application relates to the technical field of power-on of a shared card of a multi-node server and, more particularly, to a multi-node server, a power-on method of a multi-node server for a shared card, a power-on apparatus of a multi-node server for a shared card, and a non-transitory computer-readable storage medium.

### BACKGROUND

A server generally includes standby power and sore power. The standby power may refer to a standby power supply for ensuring that the server remains powered on in a non-working state. The standby power is usually small and is only used for maintaining the operation of a hardware device and a monitoring system of the server. The power consumption of the standby power supply is low, but energy saving and environmental protection still need to be paid attention to. The core power may refer to a core power supply, also known as a working power supply, and is a main power supply required for the normal operation of the server. The core power provides power to the server to drive key components such as a processor, a memory, a hard disk drive, and a cooling system. The power consumption of the core power supply depends on the performance and configuration of the server and is usually high.

After a power supply unit (PSU) is plugged in and before the server is powered on, the server is in a standby state. At this moment, the server only needs the standby power. After a power-on button of the server is pressed or a power-on instruction is issued remotely, a system power module starts to generate the core power to maintain normal system operation.

Typically, the server uses a complex programmable logic device (CPLD) or a field programmable gate array (FPGA) to monitor a voltage regulator (VR) module chip enable and a power good signal through programmed code to achieve that the power supply is gradually powered on in a predetermined sequence, wherein the power good signal is a power management signal for indicating that the power supply has been stabilized and is ready to supply power to the server.

In a multi-node server, power supplies of the nodes are independent of one another. However, there are some shared cards among the nodes, such as fan boards, riser cards (expansion cards), and network management boards, which need to be interconnected with the nodes simultaneously. Since power control systems of the nodes are independent of one another, the nodes cannot be powered on synchronously. In this case, there may be an electric leakage problem. Therefore, it is necessary to add isolation circuits for all signals interconnected with the nodes. However, too many isolation circuits may affect the card design layout and increase the hardware cost.

### SUMMARY

In view of the above problems, a multi-node server, a power-on method of a multi-node server for a shared card, a power-on apparatus of a multi-node server for a shared card, and a non-transitory computer-readable storage medium are provided to overcome or at least partly solve the above problems.

A multi-node server includes a master node, a slave node, a power-on synchronization apparatus, and at least one shared card shared between the master node and the slave node;
any target shared card being connected to the master node and the slave node, and the master node and the slave node being configured to supply power to the target shared card;
the power-on synchronization apparatus including an isolation module, a master node signal interconnection module, and a slave node signal interconnection module; the master node signal interconnection module being connected to the master node; the slave node signal interconnection module being connected to the slave node; the master node signal interconnection module being connected to the slave node signal interconnection module via the isolation module,
wherein the master node and the slave node separately supply power to the target shared card after interacting with a power-on request for the target shared card via the power-on synchronization apparatus.

In some embodiments, the isolation module is configured to isolate signals between the master node and the slave node.

In some embodiments, the power-on synchronization apparatus includes a master-slave setting module; the master node includes a first system management module, and the first system management module is connected to the master-slave setting module; and
the master-slave setting module is configured to set the first system management module as a master system management module.

In some embodiments, the slave node includes a master-slave initialization module, and the master-slave initialization module is configured to set the slave node as a subordinate node of the master node after the slave node is powered on.

In some embodiments, the master node includes a first power module, and an input end of the first power module is connected to a power supply unit; the first system management module includes a first power-on management module; and
the first power module is configured to supply power to the first power-on management module after the power supply unit is connected to the master node.

In some embodiments, the first power-on management module being configured to complete information interaction and information processing between the master node and the slave node includes:
the first power-on management module being connected to the master node signal interconnection module, so that information interaction between the first power-on management module and the slave node is performed via the power-on synchronization apparatus.

In some embodiments, the master node further includes a second power module and a first power-on control module; the first power-on control module is connected to the first system management module, and the second power module is separately connected to the first power-on control module and the target shared card,
wherein the first power-on control module is configured to output an instruction to the second power module according to an instruction outputted by the first power-on management module; and the first power-on control module is further configured to transmit a power state of the second power module to the first power-on management module; and
the second power module is configured to control power supply to the target shared card according to the instruction outputted by the first power-on control module.

In some embodiments, that the second power module is configured to control the power supply to the target shared card according to the instruction outputted by the first power-on control module includes:
the second power module supplying power to or powering off the target shared card.

In some embodiments, the first power-on control module is provided with a timer, so that the first power-on control module detects an operating state of the first power-on management module and an operating state of the first system management module.

In some embodiments, the first power-on control module is configured to filter the instruction outputted by the first power-on management module to the second power module according to an anomaly of the first system management module.

In some embodiments, the slave node includes a third power module, a fourth power module, and a second system management module; an input end of the third power module is connected to the power supply unit, and the second system management module includes a second power-on management module,
wherein the first power-on management module is configured to transmit a power-on preparation signal to the second power-on management module via the power-on synchronization apparatus;
the second power-on management module is configured to send a power-on preparation response to the first power-on management module via the power-on synchronization apparatus in response to the power-on preparation signal;
the first power-on management module is further configured to, after receiving the power-on preparation response, clear power-on completion flags of the target shared card, and send a power-on request to the second power-on management module via the power-on synchronization apparatus;
the second power-on management module is further configured to, after receiving the power-on request, supply power to the target shared card in response to the power-on request, and send a power-on request response to the first power-on management module via the power-on synchronization apparatus; and
the first power-on management module is further configured to, after receiving the power-on request response, control the second power module to supply power to the target shared card.

In some embodiments, the sending the power-on request to the second power-on management module via the power-on synchronization apparatus includes:
transmitting, by the first power-on management module, the power-on request to the master node signal interconnection module;
transmitting, by the master node signal interconnection module, the power-on request to the slave node signal interconnection module via the isolation module; and
after receiving the power-on request, transmitting, by the slave node signal interconnection module, the power-on request to the second power-on management module.

In some embodiments, the slave node further includes a second power-on control module, and the second power-on control module is connected to the second system management module; the fourth power module is separately connected to the second power-on control module and the target shared card,
wherein the first power-on control module is configured to transmit a first successful power supply signal to the first system management module in response to the second power module successfully supplying power to the target shared card;
the second power-on control module is configured to transmit a second successful power supply signal to the second system management module in response to the fourth power module successfully supplying power to the target shared card; and
the first system management module is configured to issue a power-on anomaly alarm in response to not receiving the first successful power supply signal and/or the second successful power supply signal.

In some embodiments, the first system management module is further configured to record a log for the power-on anomaly alarm in response to issuing the power-on anomaly alarm.

In some embodiments, the first system management module is configured to count the power-on completion flags in response to receiving the first successful power supply signal and/or the second successful power supply signal.

In some embodiments, the target shared card includes a card interconnection module; the master node includes a master node interconnection module; the slave node includes a slave node interconnection module; and
the card interconnection module is separately connected to the master node interconnection module and the slave node interconnection module.

In some embodiments, the power-on synchronization apparatus is disposed on any target shared card; or the power-on synchronization apparatus is an independent card.

A power-on method of the multi-node server for a shared card is further provided by the embodiments of the present application, which is applied to the multi-node server according to any one of embodiments stated above, the multi-node server includes the master node, the slave node, the power-on synchronization apparatus, and the at least one shared card shared between the master node and the slave node; and the power-on method includes:
transmitting, by the master node, the power-on request for the target shared card to the slave node via the power-on synchronization apparatus; and in response to the power-on request, transmitting, by the slave node, a power-on request response for the power-on request to the master node via the power-on synchronization apparatus, and supplying power to the target shared card; and
supplying power to the target shared card after receiving the power-on request response.

A power-on apparatus of the multi-node server for a shared card is further provided by the embodiments of the present application, which is applied to the multi-node server according to any one of embodiments stated above, the multi-node server includes the master node, the slave node, the power-on synchronization apparatus, and the at least one shared card shared between the master node and the slave node; and the power-on apparatus includes:
a request module configured to transmit, by the master node, the power-on request for the target shared card to the slave node via the power-on synchronization apparatus; and in response to the power-on request, transmit, by the slave node, a power-on request response for the power-on request to the master node via the power-on synchronization apparatus, and supply power to the target shared card; and
a power module configured to supply power to the target shared card after receiving the power-on request response.

A non-transitory computer-readable storage medium is further provided by the embodiments of the present application, wherein the non-transitory computer-readable storage medium has a computer program stored thereon, the computer program, in response to being executed by a processor, implements the power-on method of the multi-node server for the shared card stated above.

In the embodiments of the present application, the multi-node server may include the master node, the slave node, the power-on synchronization apparatus, and at least one shared card shared between the master node and the slave node. Any target shared card is connected to the master node and the slave node, and the master node and the slave node are configured to supply power to the target shared card. The power-on synchronization apparatus includes the isolation module, the master node signal interconnection module, and the slave node signal interconnection module. The master node signal interconnection module is connected to the master node. The slave node signal interconnection module is connected to the slave node. The master node signal interconnection module is connected to the slave node signal interconnection module via the isolation module. The master node and the slave node separately supply power to the target shared card after interacting with the power-on request for the target shared card via the power-on synchronization apparatus. Compared with the use of an isolation circuit, in the embodiments of the present application, it is realized that a plurality of shared cards may be synchronously supplied power by using only one power-on synchronization apparatus, thus the system design layout is optimized and the hardware cost is reduced.

### BRIEF DESCRIPTION OF THE DRAWINGS

In order to describe the technical solutions of the present application more clearly, the drawings required to be used for describing the present application is briefly introduced below. Apparently, the drawings in the following description show merely some embodiments of the present application, and a person skilled in the art may still derive other drawings according to these drawings without paying any creative efforts.

FIG. 1 is a schematic structural diagram of a multi-node server according to an embodiment of the present application;

FIG. 2 is a schematic structural diagram of a dual-node server according to an embodiment of the present application;

FIG. 3 is a schematic structural diagram of a node X according to an embodiment of the present application;

FIG. 4a is a flowchart of steps of a power-on method of a multi-node server for a shared card according to an embodiment of the present application;

FIG. 4b is a flowchart of steps of powering on a shared card according to an embodiment of the present application;

FIG. 5 is a schematic structural diagram of a power-on apparatus of a multi-node server for a shared card according to an embodiment of the present application; and

FIG. 6 is a schematic structural diagram of a non-transitory computer-readable storage medium according to an embodiment of the present application.

### DETAILED DESCRIPTION

In order to make the above objectives, features, and advantages of the present application more obvious and easier to understand, the present application will be further described in detail with reference to the drawings and implementations. Apparently, the described embodiments are some rather than all of the embodiments of the present application. All other embodiments obtained by a person skilled in the art without paying any creative efforts shall fall within the protection scope of the present application.

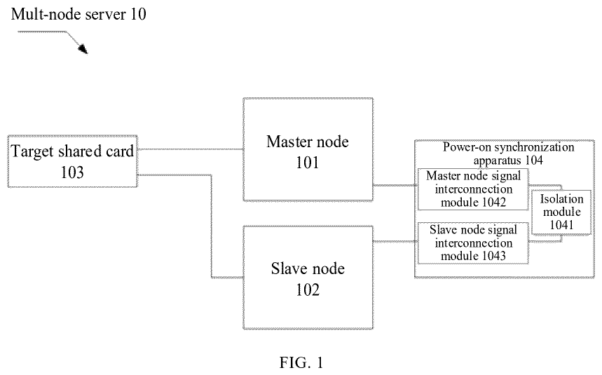

An existing server typically uses a CPLD or an FPGA to control nodes to be powered on in a predetermined sequence. Multi-node power-on control systems are independent of one another. By adding isolation circuits for all signals interconnected with the nodes, the electric leakage problem caused by asynchronization is avoided. However, adding isolation circuits for all multi-node interconnection signals may easily lead to too many isolation circuits, thus the card design layout is affected and the hardware cost is increased. In order to optimize the multi-node power-on control systems to realize synchronous power-on of all shared power supplies of a plurality of nodes, reduce hardware isolation circuits, optimize the system design layout, and reduce the hardware cost, a multi-node server is provided by an embodiment of the present application, as shown in FIG. 1. FIG. 1 shows a schematic structural diagram of a multi-node server according to an embodiment of the present application. As shown in FIG. 1, the multi-node server 10 may include a master node 101, a slave node 102, a power-on synchronization apparatus 104, and at least one shared card shared between the master node 101 and the slave node 102. The shared card may refer to a fan board, a Riser card, a network management board, or the like.

Any target shared card 103 is connected to the master node 101 and the slave node 102, and the master node 101 and the slave node 102 are configured to supply power to the target shared card 103.

The power-on synchronization apparatus 104 includes an isolation module 1041, a master node signal interconnection module 1042, and a slave node signal interconnection module 1043. The master node signal interconnection module 1042 is connected to the master node 101. The slave node signal interconnection module 1043 is connected to the slave node 102. The master node signal interconnection module 1042 is connected to the slave node signal interconnection module 1043 via the isolation module 1041.

The master node 101 and the slave node 102 separately supply power to the target shared card 103 after interacting with a power-on request for the target shared card 103 via the power-on synchronization apparatus 104.

In the embodiments of the present application, the master node 101 may refer to one server in the multi-node server 10, and the slave node 102 may refer to another server or multiple servers in the multi-node server. Exemplarily, the multi-node server 10 may be a dual-node server, a three-node server, a four-node server, or the like, which is not limited in the embodiments of the present application.

For any target shared card 103 in the at least one shared card, the target shared card 103 may be connected to the master node 101 and the slave node 102, and the master node 101 and the slave node 102 may be configured to supply power to the target shared card 103. Exemplarily, the master node 101 and the slave node 102 may also be connected to any other shared card and supply power to the any shared card, which is not limited in the embodiments of the present application.

The power-on synchronization apparatus 104 is disposed between the master node 101 and the slave node 102. The power-on synchronization apparatus 104 includes the isolation module 1041, the master node signal interconnection module 1042, and the slave node signal interconnection module 1043, wherein the power-on synchronization apparatus 104 is connected to the master node 101 via the master node signal interconnection module 1042; the power-on synchronization apparatus 104 is connected to the slave node 102 via the slave node signal interconnection module 1043; and the master node signal interconnection module 1042 is connected to the slave node signal interconnection module 1043 via the isolation module 1041. The isolation module 1041 may be configured to isolate signals between the master node 101 and the slave node 102, thereby electric leakage from the master node 101 to the slave node 102 is avoided, or electric leakage from the slave node 102 to the master node 101 is avoided.

In some feasible embodiments, the master node 101 may transmit a power-on request to the master node signal interconnection module 1042. After receiving the power-on request, the master node signal interconnection module 1042 may output the power-on request to the slave node signal interconnection module 1043 via the isolation module 1041. The power-on request may be a request to supply power to the target shared card 103.

After receiving the power-on request, the slave node signal interconnection module 1043 may output the power-on request to the slave node 102. The slave node 102 may supply power to the target shared card 103 in response to the power-on request. In addition, the slave node 102 may transmit a power-on request response to the master node 101 in response to the power-on request, wherein the power-on request response may be a signal of the slave node 102 responding to the power-on request. Based on this signal, the master node 101 may determine that the slave node 102 has received the power-on request and supplies power to the target shared card 103.

The transmission path of the power-on request response is as follows: the slave node 102→the slave node signal interconnection module 1043→the isolation module 1041→the master node signal interconnection module 1042→the master node 101.

After receiving the power-on request response, the master node 101 may supply power to the target shared card 103.

In the embodiments of the present application, the multi-node server 10 may include the master node 101, the slave node 102, the power-on synchronization apparatus 104, and at least one shared card shared between the master node 101 and the slave node 102. Any target shared card 103 is connected to the master node 101 and the slave node 102, and the master node 101 and the slave node 102 are configured to supply power to the target shared card 103. The power-on synchronization apparatus 104 includes the isolation module 1041, the master node signal interconnection module 1042, and the slave node signal interconnection module 1043. The master node signal interconnection module 1042 is connected to the master node 101. The slave node signal interconnection module 1043 is connected to the slave node 102. The master node signal interconnection module 1042 is connected to the slave node signal interconnection module 1043 via the isolation module 1041. The master node 101 and the slave node 102 separately supply power to the target shared card 103 after interacting with the power-on request for the target shared card 103 via the power-on synchronization apparatus 104. Compared with the use of an isolation circuit, in the embodiments of the present application, it is realized that a plurality of shared cards may be synchronously supplied power by using only one power-on synchronization apparatus 104, thus the system design layout is optimized and the hardware cost is reduced.

In some embodiments of the present application, the power-on synchronization apparatus 104 includes a master-slave setting module. The master node 101 includes a first system management module, the first system management module is connected to the master-slave setting module.

The master-slave setting module is configured to set the first system management module as a master system management module.

In some feasible embodiments, the power-on synchronization apparatus 104 further includes the master-slave setting module, and the master node 101 includes the first system management module, the first system management module is connected to the master-slave setting module in the power-on synchronization apparatus 104. Therefore, at an initialized node, the master-slave setting module may set the first system management module connected thereto as the master system management module. The master system management module may be configured to initiate a power-on request or the like, so that the power-on program corresponding to the method of the embodiments of the present application may be performed normally without external setting.

In some embodiments of the present application, the slave node 102 includes a master-slave initialization module, and the master-slave initialization module is configured to set the slave node 102 as a subordinate node of the master node 101 after the slave node 102 is powered on.

In some possible embodiments, the slave node 102 includes the master-slave initialization module, the master-slave initialization module may be configured to set the slave node 102 as the subordinate node of the master node 101 after the slave node 102 is powered on. Thus, the slave node 102 does not serve as the node initiating the power-on request, but only as the subordinate node of the master node 101 responding to the power-on request.

In some embodiments of the present application, the master node 101 includes a first power module, and an input end of the first power module is connected to a power supply unit. The first system management module includes a first power-on management module.

The first power module is configured to supply power to the first power-on management module after the power supply unit is connected to the master node 101.

In some feasible embodiments, the master node 101 may be provided with the first power module, and the input end of the first power module may be connected to the power supply unit. Moreover, the first system management module is provided with the first power-on management module, the first power-on management module is connected to the first power module. After the power supply unit is connected, the first power module may automatically supply power to the first power-on management module.

The first power-on management module may be configured to complete information interaction and information processing between the master node 101 and the slave node 102. Exemplarily, the first power-on management module may be connected to the master node signal interconnection module 1042, thereby information interaction between the first power-on management module and the slave node 102 is performed via the power-on synchronization apparatus 104.

In some embodiments of the present application, the master node 101 further includes a second power module and a first power-on control module. The first power-on control module is connected to the first system management module, and the second power module is separately connected to the first power-on control module and the target shared card 103.

The first power-on control module is configured to output an instruction to the second power module according to an instruction outputted by the first power-on management module, and the first power-on control module is further configured to transmit a power state of the second power module to the first power-on management module.

The second power module is configured to control power supply to the target shared card 103 according to the instruction outputted by the first power-on control module.

In some feasible embodiments, the master node 101 may further include a second power module and a first power-on control module, wherein the second power module may be configured to supply power to a shared card, the first power-on control module may be configured to output, according to an information processing result of the power-on management module, a control signal to control a power chip of the second power module to control power supply such as outputting/cutting off power.

The first power-on control module may be configured to connect the first system management module and the second power module. The first power-on control module may be connected to the first power-on management module in the first system management module to receive a signal outputted by the first power-on management module. The second power module may also be connected to each shared card in addition to the first power-on control module. Exemplarily, the second power module may be connected to the target shared card 103.

In response to determining that the power supply to the target shared card 103 needs to be controlled, the first power-on management module may output a power supply control instruction to the first power-on control module. At this moment, the first power-on control module may output a power supply control instruction to the second power module in response to the power supply control instruction. The second power module may control power supply to the target shared card 103 in response to the power supply control instruction. Exemplarily, the second power module may perform an operation of supplying power or powering off the target shared card 103 in response to the power supply control instruction.

In some feasible embodiments, the first power-on control module may be further configured to transmit a power state of the second power module to the first power-on management module so that the first power-on management module may control the second power module based on the power state of the second power module.

In some embodiments of the present application, the first power-on control module is configured to filter an instruction outputted by the first power-on management module to the second power module according to an anomaly of the first system management module.

In some feasible embodiments, the first power-on control module is located between the first power-on management module and the second power module, and may play a role in isolation. The first power-on control module may detect whether the first power-on management module in the first system management module and the first system management module have anomalies. In response to the first power-on control module detecting that the first power-on management module in the first system management module or the first system management module has an anomaly, the instructions transmitted by the first power-on management module to the second power module may be filtered to ensure that the system maintains the current power supply state and avoids abnormal power failure of the system.

In some embodiments of the present application, the slave node 102 includes a third power module, a fourth power module, and a second system management module. An input end of the third power module is connected to a power supply unit. The second system management module includes a second power-on management module.

The first power-on management module is configured to transmit a power-on preparation signal to the second power-on management module via the power-on synchronization apparatus 104.

The second power-on management module is configured to send a power-on preparation response to the first power-on management module via the power-on synchronization apparatus 104 in response to the power-on preparation signal.

The first power-on management module is further configured to, after receiving the power-on preparation response, clear power-on completion flags of the target shared card 103, and send a power-on request to the second power-on management module via the power-on synchronization apparatus 104.

The second power-on management module is further configured to, after receiving the power-on request, supply power to the target shared card 103 in response to the power-on request, and send a power-on request response to the first power-on management module via the power-on synchronization apparatus 104.

The first power-on management module is further configured to control the second power module to supply power to the target shared card 103 after receiving the power-on request response.

In some possible embodiments, the slave node 102 may include a third power module, a fourth power module, and a second system management module, wherein an input end of the third power module may be connected to a power supply unit, and an output end of the third power module may be connected to the second power-on management module in the second system management module; and after the power supply unit is connected, the third power module may automatically supply power to the second power-on management module.

In the process of powering on the target shared card 103, the first power-on management module may first transmit the power-on preparation signal to the second power-on management module via the power-on synchronization apparatus 104. The first power-on management module may first transmit the power-on preparation signal to the master node signal interconnection module 1042. The power-on preparation signal may refer to a ready signal for indicating that the first power-on management system is ready to supply power to the target shared card 103.

The master node signal interconnection module 1042 may then transmit the power-on preparation signal to the slave node signal interconnection module 1043 via the isolation module 1041. The slave node signal interconnection module 1043 may transmit the received power-on preparation signal to the second power-on management module.

After receiving the power-on preparation signal, the second power-on management module may send, in response to the power-on preparation signal, the power-on preparation response to the first power-on management module via the power-on synchronization apparatus 104, wherein the power-on preparation response may refer to a response of the second power-on management module to the power-on preparation signal, and the response may correspond to a signal so that the first power-on management module determines that the second power-on management module is ready to supply power to the target shared card 103.

The second power-on management module may transmit the power-on preparation response to the slave node signal interconnection module 1043. The slave node signal interconnection module 1043 may then transmit the power-on preparation response to the master node signal interconnection module 1042 via the isolation module 1041.

After receiving the power-on preparation response, the master node signal interconnection module 1042 may transmit the power-on preparation response to the first power-on management module. After receiving the power-on preparation response, the first power-on management module may clear the power-on completion flags n of the target shared card 103 and send a power-on request to the second power-on management module via the power-on synchronization apparatus 104. Clearing the power-on completion flags is to ensure that the system or device may be correctly initialized and enter the normal working state after being powered on, and is used to indicate whether the system has completed the necessary initialization process. The power-on request may be configured for requesting the second power-on management module to control the fourth power module to supply power to the target shared card 103.

The power-on request may be first transmitted by the first power-on management module to the master node signal interconnection module 1042, and then transmitted by the master node signal interconnection module 1042 to the slave node signal interconnection module 1043 via the isolation module 1041. After receiving the power-on request, the slave node signal interconnection module 1043 may transmit the power-on request to the second power-on management module.

After receiving the power-on request, the second power-on management module may supply power to the target shared card 103 in response to the power-on request. At the same time, the second power-on management module may send, in response to the power-on request, a power-on request response to the first power-on management module via the power-on synchronization apparatus 104. The power-on request response may be used for the first power-on management module to determine that the second power-on management module has controlled the fourth power module to supply power to the target shared card 103.

The power-on request response may be first transmitted by the second power-on management module to the slave node signal interconnection module 1043, and then transmitted by the slave node signal interconnection module 1043 to the master node signal interconnection module 1042 via the isolation module 1041. After receiving the power-on request response, the master node signal interconnection module 1042 may control the second power module to supply power to the target shared card 103. At this moment, the power-on of the target shared card 103 is completed.

In some embodiments of the present application, the slave node 102 further includes a second power-on control module, the second power-on control module is connected to the second system management module. The fourth power module is separately connected to the second power-on control module and the target shared card 103.

The first power-on control module is configured to transmit a first successful power supply signal to the first system management module in response to the second power module successfully supplying power to the target shared card 103.

The second power-on control module is configured to transmit a second successful power supply signal to the second system management module in response to the fourth power module successfully supplying power to the target shared card 103.

The first system management module is configured to issue a power-on anomaly alarm in response to not receiving the first successful power supply signal and/or the second successful power supply signal.

In some feasible embodiments, the slave node 102 may further include a second power-on control module, the second power-on control module may be connected to the second system management module, and the fourth power module may be separately connected to the second power-on control module and the target shared card 103, wherein the second power-on control module may be configured to connect the second power-on management module and the fourth power module to isolate the second power-on management module and the fourth power module; in response to the second power-on management module or the second system management module having an anomaly, the second power-on control module may filter out the information transmitted by the second power-on management module to the fourth power module, so as to ensure that the system maintains the current power supply state and avoid abnormal power failure of the system.

In practical application, the first power-on control module may transmit the first successful power supply signal to the first system management module in response to the second power module successfully supplying power to the target shared card 103. The second power-on control module may also transmit the second successful power supply signal to the second system management module in response to the fourth power module successfully supplying power to the target shared card 103. The first successful power supply signal may refer to that the second power module successfully supplies power to the target shared card 103, and the second successful power supply signal may refer to that the fourth power module successfully supplies power to the target shared card 103.

After receiving the second successful power supply signal, the second system management module may transmit the second successful power supply signal to the first system management module via the power-on synchronization apparatus 104. In response to the first system management module not receiving the first successful power supply signal and/or the second successful power supply signal, it may be determined that there is an anomaly in the current power-on. At this moment, the first system management module may issue a power-on anomaly alarm to inform an administrator that there is an anomaly in the current power-on for the target shared card 103.

In some embodiments of the present application, the first system management module is further configured to record a log for the power-on anomaly alarm in response to issuing the power-on anomaly alarm.

In some feasible embodiments, while issuing the power-on anomaly alarm, the first system management module may record a log for the power-on anomaly alarm so as to perform subsequent operations such as troubleshooting, which is not limited in the embodiments of the present application.

In some embodiments of the present application, the first system management module counts the power-on completion flags in response to receiving the first successful power supply signal and/or the second successful power supply signal.

In some feasible embodiments, the first system management module may count the power-on completion flags in response to receiving the first successful power supply signal and/or the second successful power supply signal. Exemplarily, in response to receiving the first successful power supply signal, the power-on completion flags n may be incremented by 1. Then, the first system management module may determine whether the finally obtained n is equal to N, wherein N may be set according to an actual power supply situation. For example, N may be related to a quantity of nodes, which is not limited in the embodiments of the present application.

In response to determining that n is equal to N, it may be determined that synchronous power-on is completed. On the contrary, it may be determined that the power-on of the slave node 102 has not been completed. At this moment, the remaining slave nodes 102 may be waited to complete power supply.

In some embodiments of the present application, the target shared card 103 includes a card interconnection module. The master node 101 includes a master node interconnection module, and the slave node 102 includes a slave node interconnection module.

The card interconnection module is separately connected to the master node interconnection module and the slave node interconnection module.

In some feasible embodiments, the target shared card 103 may include a card interconnection module; the master node 101 may further include a master node interconnection module; and the slave node 102 may further include a slave node interconnection module, wherein the card interconnection module is separately connected to the master node interconnection module and the slave node interconnection module so that the target shared card 103 receives signals from the master node 101 and the slave node 102.

In some embodiments of the present application, the power-on synchronization apparatus 104 is disposed on any target shared card 103; or the power-on synchronization apparatus 104 is an independent card.

In some feasible embodiments, the power-on synchronization apparatus 104 may be disposed on any target shared card 103, or may be an independent card, which is not limited in the embodiments of the present application. It needs to be noted that there is one power-on synchronization apparatus 104 in the entire multi-node server 10.

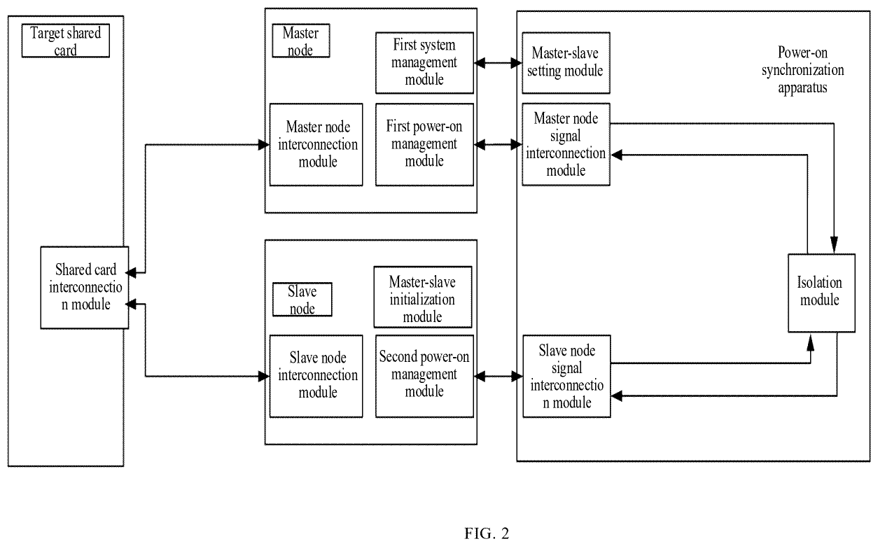

Exemplarily, taking a dual-node server as an example, as shown in FIG. 2, the master node includes a master node interconnection module, a first system management module, and a first power-on management module. The slave node includes a slave node interconnection module, a second power-on management module, and a master-slave initialization module. The power-on synchronization apparatus includes a master-slave setting module, a master node signal interconnection module, an isolation module, and a slave node signal interconnection module. The target shared card includes a shared card interconnection module.

The shared card interconnection module is separately connected to the master node interconnection module and the slave node interconnection module to transmit signals between the target shared card and the master node as well as the slave node. The first system management module is connected to the master-slave setting module to set the first system management module as the master system management module at initialization. The master-slave initialization module may set the second system management module as a slave system management module during initialization.

The first power-on management module is connected to the master node signal interconnection module. The second power-on management module is connected to the slave node signal interconnection module. The master node signal interconnection module is connected to the slave node signal interconnection module via the isolation module. The master node signal interconnection module may output a signal outputted by the master node to the isolation module, and input a signal to the slave node via the isolation module. The slave node signal interconnection module may output a signal outputted by the slave node to the isolation module, and output a signal to the master node via the isolation module.

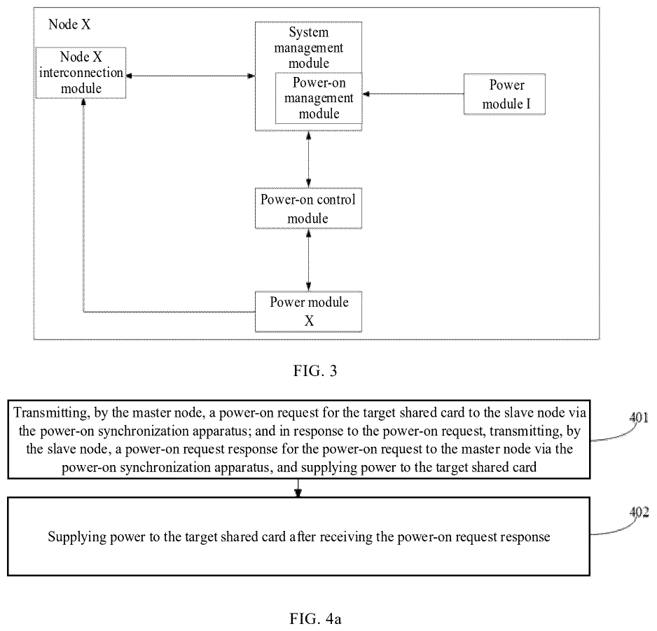

As shown in FIG. 3, for any node X in a multi-node server, the any node X may include a system management module, a power-on control module, a power module I, and a power module X. The system management module is provided with a power-on management module. The power module I is connected to a power supply unit. After the power supply unit is connected, the power module I may automatically supply power to the power-on management module.

The system management module may be connected to a node X interconnection module, and performs data interaction with a shared card via the node X interconnection module. The power module X may be connected to the node X interconnection module, and supplies power to the shared card via the node X interconnection module.

The power-on management module of the system management module may perform data interaction with a power-on control module via an inter-integrated circuit (I2C). The power-on management module and the power-on control module are provided with input/output interfaces for data interaction. In addition, a Watchdog timer is further disposed so that the power-on control module detects the operating state of the power-on management module and the operating state of the system management module.

The power-on control module may transmit an enable signal to the power module X or receive a power ok signal from the power module X. The power-on control module may also receive an alarm signal from the power module X for subsequent alarm processing.

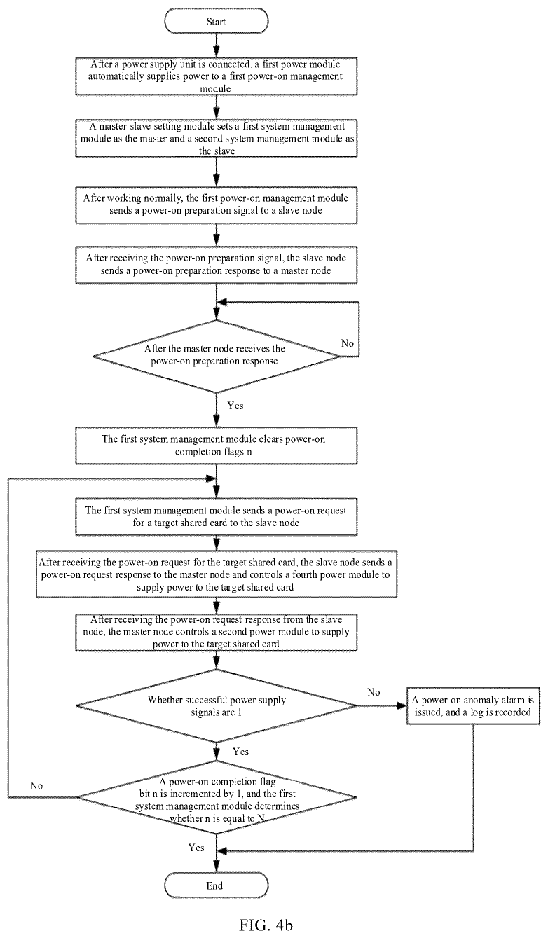

Based on the above multi-node server, a power-on method of a multi-node server for a shared card is further provided by an embodiment of the present application, as shown in FIG. 4a. FIG. 4a is a flowchart of steps of a power-on method of a multi-node server for a shared card according to an embodiment of the present application. The power-on method may be applied to the multi-node server as mentioned in the above embodiments, and the multi-node server may include a master node, a slave node, a power-on synchronization apparatus, and at least one shared card shared between the master node and the slave node.

As shown in FIG. 4a, the power-on method may include the following steps.

Step 401, transmitting, by the master node, a power-on request for the target shared card to the slave node via the power-on synchronization apparatus; and in response to the power-on request, transmitting, by the slave node, a power-on request response for the power-on request to the master node via the power-on synchronization apparatus, and supplying power to the target shared card.

In some feasible embodiments, the master node may transmit a power-on request to the master node signal interconnection module. After receiving the power-on request, the master node signal interconnection module may output the power-on request to the slave node signal interconnection module via the isolation module.

After receiving the power-on request, the slave node signal interconnection module may output the power-on request to the slave node. The slave node may supply power to the target shared card in response to the power-on request. In addition, the slave node may transmit a power-on request response to the master node in response to the power-on request.

Step 402, supplying power to the target shared card after receiving the power-on request response.

After receiving the power-on request response, the master node may supply power to the target shared card.

Exemplarily, as shown in FIG. 4b:
(1) After a power supply unit is connected, a first power module automatically supplies power to a first power-on management module.
(2) A master-slave setting module sets a first system management module as the master and a second system management module as the slave.
(3) After working normally, the first power-on management module sends a power-on preparation signal to a slave node.
(4) After receiving the power-on preparation signal, the slave node sends a power-on preparation response to the master node.
(5) After the master node receives the power-on preparation response, the first system management module clears power-on completion flags n and sends a power-on request for the target shared card to the slave node.
(6) After receiving the power-on request for the target shared card, the slave node sends a power-on request response to the master node and controls a fourth power module to supply power to the target shared card.
(7) After receiving the power-on request response from the slave node, the master node controls a second power module to supply power to the target shared card and monitors whether successful power supply signals for the master node and the slave node are received. In response to receiving the successful power supply signals, the successful power supply signal is 1. It is determined whether the successful power supply signals for the master node and the slave node are both 1. In response to the successful power supply signals for the master node and the slave node not being 1, a power-on anomaly alarm is issued, and a log is recorded. Conversely, in response to the successful power supply signals for the master node and the slave node being 1, (8) is performed.
(8) A power-on completion flag bit n is incremented by 1. The first system management module determines whether n is equal to N. In response to n being equal to N, synchronous power-on is completed; or otherwise, in response to n being not equal to N, step (6) is performed.

In the embodiments of the present application, the master node transmits the power-on request for the target shared card to the slave node via the power-on synchronization apparatus. In response to the power-on request, the slave node transmits the power-on request response for the power-on request to the master node via the power-on synchronization apparatus, and supplies power to the target shared card. After receiving the power-on request response, power is supplied to the target shared card. Compared with the use of an isolation circuit, in the embodiments of the present application, it is realized that a plurality of shared cards may be synchronously supplied power by using only one power-on synchronization apparatus, thus the system design layout is optimized and the hardware cost is reduced.

It should be noted that, for the sake of simplicity, the method embodiments are described as a series of action combinations, but a person skilled in the art will recognize that the embodiments of the present application are not limited by the sequence of actions described, and certain steps may be performed in another order or at the same time according to the embodiments of the present application. In addition, it should be understood by a person skilled in the art that the related actions of the embodiments described in the present specification are not definitely necessary for the embodiments of the present application.

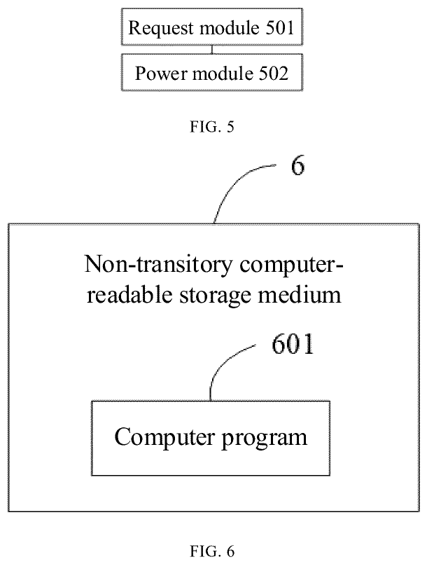

Referring to FIG. 5, FIG. 5 is a schematic structural diagram of a power-on apparatus of a multi-node server for a shared card according to an embodiment of the present application. The power-on apparatus may be applied to the multi-node server as mentioned in the above embodiments, and the multi-node server may include a master node, a slave node, a power-on synchronization apparatus, and at least one shared card between the master node and the slave node.

As shown in FIG. 5, the apparatus may include the following modules:
a request module 501 configured to transmit, by the master node, the power-on request for the target shared card to the slave node via the power-on synchronization apparatus; and in response to the power-on request, transmit, by the slave node, a power-on request response for the power-on request to the master node via the power-on synchronization apparatus, and supply power to the target shared card; and
a power module 502 configured to supply power to the target shared card after receiving the power-on request response.

In the embodiments of the present application, the master node transmits the power-on request for the target shared card to the slave node via the power-on synchronization apparatus. In response to the power-on request, the slave node transmits the power-on request response for the power-on request to the master node via the power-on synchronization apparatus, and supplies power to the target shared card. After receiving the power-on request response, power is supplied to the target shared card. Compared with the use of an isolation circuit, in the embodiments of the present application, it is realized that a plurality of shared cards may be synchronously supplied power by using only one power-on synchronization apparatus, thus the system design layout is optimized and the hardware cost is reduced.

A non-transitory computer-readable storage medium is further provided by an embodiment of the present application. As shown in FIG. 6, the non-transitory computer-readable storage medium 6 has a computer program 601 stored thereon, the computer program 601, in response to being executed by a processor, implements the above power-on method of the multi-node server for the shared card.

Since apparatus embodiments are substantially similar to the method embodiments, the description is relatively simple, and reference may be made to the description of the method embodiments.

The embodiments are described herein in a progressive manner. Each embodiment focuses on the difference from another embodiment, and the same and similar not parts between the embodiments may refer to each other.

A person skilled in the art should understand that the embodiments of the present application may be provided as a method, an apparatus, or a computer program product. Therefore, the present application may use a form of hardware only embodiments, software only embodiments, or embodiments with a combination of software and hardware. Moreover, the present application may be in a form of a computer program product that is implemented on one or more computer-usable storage media (including, but not limited to, a magnetic disk memory, a compact disc read-only memory (CD-ROM), an optical memory, and the like) that include computer-usable program code.

The embodiments of the present application are described with reference to the flowcharts and/or block diagrams of the method, the terminal device (system), and the computer program product according to the embodiments of the present application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing terminal device to generate a machine, so that the instructions executed by a computer or a processor of another programmable data processing terminal device generate an apparatus for implementing a function in one or more processes in the flowcharts and/or in one or more blocks in the block diagrams.

These computer program instructions may alternatively be stored in a computer readable memory that may instruct the computer or another programmable data processing terminal device to work in a manner, so that the instructions stored in the computer readable memory generate an artifact that includes an instruction apparatus. The instruction apparatus implements a function in one or more processes in the flowcharts and/or in one or more blocks in the block diagrams.

These computer program instructions may alternatively be loaded onto a computer or another programmable data processing terminal device, so that a series of operations and steps are performed on the computer or another programmable terminal device, thereby generating computer-implemented processing. Therefore, the instructions executed on the computer or another programmable terminal device provide steps for implementing a function in one or more processes in the flowcharts and/or in one or more blocks in the block diagrams.

Although embodiments of the present application have been described, a person skilled in the art may make changes and modifications to these embodiments once they learn the basic inventive concept. Therefore, the appended claims are intended to be construed as covering the embodiments and all changes and modifications falling within the scope of the embodiments of the present application.

Finally, it should be further noted that, in this specification, relationship terms such as first and second are only used to distinguish an entity or operation from another entity or operation, but do not necessarily require or imply that there is any actual relationship or order between these entities or operations. Moreover, the terms “include”, “include” or any other variants thereof are intended to cover non-exclusive inclusion, so that a process, method, article or terminal device including a series of elements not only includes those elements, but also includes those elements that are not explicitly listed, or also includes elements inherent to this process, method, article or terminal device. Without more restrictions, the elements defined by the sentence “including a . . . ” do not exclude the existence of other identical elements in the process, method, article, or terminal device including the elements.

The above are detailed descriptions of the provided multi-node server, a power-on method of a multi-node server for a shared card, a power-on apparatus of a multi-node server for a shared card, and a non-transitory computer-readable storage medium. Examples are used herein for illustration of the principles and embodiments of the present application. The description of the above embodiments is only used to help illustrate the method and its core principles of the present application. Moreover, a person skilled in the art may make various modifications in terms of embodiments and scope of application in accordance with the ideas of the present application. In summary, the content of this specification shall not be construed as a limitation to the present application.

1. A multi-node server, comprising a master node, a slave node, a power-on synchronization apparatus, and at least one shared card shared between the master node and the slave node;
any target shared card being connected to the master node and the slave node, and the master node and the slave node being configured to supply power to the target shared card;
the power-on synchronization apparatus comprising an isolation module, a master node signal interconnection module, and a slave node signal interconnection module; the master node signal interconnection module being connected to the master node; the slave node signal interconnection module being connected to the slave node; the master node signal interconnection module being connected to the slave node signal interconnection module via the isolation module, wherein the master node and the slave node separately supply power to the target shared card after interacting with a power-on request for the target shared card via the power-on synchronization apparatus.

2. The multi-node server according to claim 1, wherein
the isolation module is configured to isolate signals between the master node and the slave node.

3. The multi-node server according to claim 1, wherein
the power-on synchronization apparatus comprises a master-slave setting module; the master node comprises a first system management module, and the first system management module is connected to the master-slave setting module; and
the master-slave setting module is configured to set the first system management module as a master system management module.

4. The multi-node server according to claim 3, wherein
the slave node comprises a master-slave initialization module, and the master-slave initialization module is configured to set the slave node as a subordinate node of the master node after the slave node is powered on.

5. The multi-node server according to claim 3, wherein the master node comprises a first power module, and an input end of the first power module is connected to a power supply unit; the first system management module comprises a first power-on management module; and
the first power module is configured to supply power to the first power-on management module after the power supply unit is connected to the master node.

6. The multi-node server according to claim 5, wherein
the first power-on management module being configured to complete information interaction and information processing between the master node and the slave node comprises:
the first power-on management module being connected to the master node signal interconnection module, so that information interaction between the first power-on management module and the slave node is performed via the power-on synchronization apparatus.

7. The multi-node server according to claim 5, wherein the master node further comprises a second power module and a first power-on control module; the first power-on control module is connected to the first system management module, and the second power module is separately connected to the first power-on control module and the target shared card,
wherein the first power-on control module is configured to output an instruction to the second power module according to an instruction outputted by the first power-on management module; and the first power-on control module is further configured to transmit a power state of the second power module to the first power-on management module; and
the second power module is configured to control power supply to the target shared card according to the instruction outputted by the first power-on control module.

8. The multi-node server according to claim 7, wherein that the second power module is configured to control the power supply to the target shared card according to the instruction outputted by the first power-on control module comprises:
the second power module supplying power to or powering off the target shared card.

9. The multi-node server according to claim 7, wherein
the first power-on control module is provided with a timer, so that the first power-on control module detects an operating state of the first power-on management module and an operating state of the first system management module.

10. The multi-node server according to claim 7, wherein
the first power-on control module is configured to filter the instruction outputted by the first power-on management module to the second power module according to an anomaly of the first system management module.

11. The multi-node server according to claim 7, wherein the slave node comprises a third power module, a fourth power module, and a second system management module; an input end of the third power module is connected to the power supply unit, and the second system management module comprises a second power-on management module,
wherein the first power-on management module is configured to transmit a power-on preparation signal to the second power-on management module via the power-on synchronization apparatus;
the second power-on management module is configured to send a power-on preparation response to the first power-on management module via the power-on synchronization apparatus in response to the power-on preparation signal;
the first power-on management module is further configured to, after receiving the power-on preparation response, clear power-on completion flags of the target shared card, and send a power-on request to the second power-on management module via the power-on synchronization apparatus;
the second power-on management module is further configured to, after receiving the power-on request, supply power to the target shared card in response to the power-on request, and send a power-on request response to the first power-on management module via the power-on synchronization apparatus; and
the first power-on management module is further configured to, after receiving the power-on request response, control the second power module to supply power to the target shared card.

12. The multi-node server according to claim 11, wherein the sending the power-on request to the second power-on management module via the power-on synchronization apparatus comprises:
transmitting, by the first power-on management module, the power-on request to the master node signal interconnection module;
transmitting, by the master node signal interconnection module, the power-on request to the slave node signal interconnection module via the isolation module; and
after receiving the power-on request, transmitting, by the slave node signal interconnection module, the power-on request to the second power-on management module.

13. The multi-node server according to claim 11, wherein the slave node further comprises a second power-on control module, and the second power-on control module is connected to the second system management module; the fourth power module is separately connected to the second power-on control module and the target shared card,
wherein the first power-on control module is configured to transmit a first successful power supply signal to the first system management module in response to the second power module successfully supplying power to the target shared card;
the second power-on control module is configured to transmit a second successful power supply signal to the second system management module in response to the fourth power module successfully supplying power to the target shared card; and
the first system management module is configured to issue a power-on anomaly alarm in response to not receiving the first successful power supply signal and/or the second successful power supply signal.

14. The multi-node server according to claim 13, wherein
the first system management module is further configured to record a log for the power-on anomaly alarm in response to issuing the power-on anomaly alarm.

15. The multi-node server according to claim 13, wherein
the first system management module is configured to count the power-on completion flags in response to receiving the first successful power supply signal and/or the second successful power supply signal.

16. The multi-node server according to claim 1, wherein the target shared card comprises a card interconnection module; the master node comprises a master node interconnection module; the slave node comprises a slave node interconnection module; and
the card interconnection module is separately connected to the master node interconnection module and the slave node interconnection module.

17. The multi-node server according to claim 1, wherein
the power-on synchronization apparatus is disposed on any target shared card; or the power-on synchronization apparatus is an independent card.

18. A power-on method of the multi-node server for a shared card, applied to the multi-node server according to claim 1, the multi-node server comprising the master node, the slave node, the power-on synchronization apparatus, and the at least one shared card shared between the master node and the slave node; and the power-on method comprising:
transmitting, by the master node, the power-on request for the target shared card to the slave node via the power-on synchronization apparatus; and in response to the power-on request, transmitting, by the slave node, a power-on request response for the power-on request to the master node via the power-on synchronization apparatus, and supplying power to the target shared card; and
supplying power to the target shared card after receiving the power-on request response.

19. (canceled)

20. A non-transitory computer-readable storage medium, wherein the non-transitory computer-readable storage medium has a computer program stored thereon, the computer program, in response to being executed by a processor, implements the power-on method of the multi-node server for the shared card according to claim 18.

21. The multi-node server according to claim 1, wherein the target shared card refers to any one of the at least one shared card.
